(19) United States
(12) Patent Application Publication
(10) Pub. No.: US 2004/0059887 A1
(43) Pub. Date: Mar. 25, 2004

(54) Cache memory

(76) Inventor: K. S. Venkatraman, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/255,500

(22) Filed: Sep. 25, 2002

(51) Int. Cl. G06F 12/10

(52) U.S. Cl. 711/207; 711/206

(57) ABSTRACT

The claimed subject matter facilitates a cache to translate a virtual address to a physical address.

### BACKGROUND

The present disclosure is related to cache memory, and more particularly, to cache memory address translation.

As is well known, a cache or cache memory stores information, such as for a computer or computing system. The speed performance of a cache tends to decrease data retrieval times for a processor. The cache stores specific subsets of data in high-speed memory. A few examples of data include instructions and addresses.

A cache location may be accessed based at least in part on a memory address. Typically, however, a cache operates at least in part by receiving a virtual memory address and translating it into a physical memory address. The translation may include a plurality of memory accesses, commonly referred to here as “levels of translation,” for performing the intermediate translations. Commonly, a Translation Look-aside Buffer (TLB) may facilitate the translation by storing a plurality of page tables for processing the intermediate levels of translation. The page tables are accessed in a manner commonly referred to as “page walk”.

A cache designer, for example, may choose to design a cache to support different modes of operation. For example, a legacy mode for a 32-bit instruction set may utilize two levels of translation. State of the art modes, such as, a 64-bit instruction set, for example, may utilize four levels of translation. However, the increased latency associated with the additional number of page table lookups may degrade the TLB performance. Thus, the cache designer may desire an address translation approach or technique to support the legacy and state of the art modes, but that may also address the increased latency that often accompanies additional page tables. Prior art cache architectures typically do not efficiently support modes of operation. For example, a mode of operation that employs a 64-bit instruction set with four levels of translation results in decreased TLB performance because of the increased latency associated with additional page table accesses. Typically, a page table access consumes several clock cycles. Therefore, in one example, this mode of operation results in a latency of 28 clock cycles. Meanwhile, the processor may have been idle for some or all of the 28 clock cycles as it waits for the completion of the address translation. Therefore, modes of operations that utilize more than one levels of translation may result in a degradation of processor performance or TLB performance, or both. Thus, an inverse relationship may typically exist between processor or TLB performance and the number of level of translations utilized for a mode of operation.

### BRIEF DESCRIPTION OF THE DRAWINGS

Claimed subject matter is particularly and distinctly pointed out in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram illustrating an embodiment of a cache in accordance with the claimed subject matter.

FIG. 2 is a schematic diagram illustrating the embodiment of FIG. 2, providing additional implementation aspects.

FIG. 3 is a block diagram illustrating a system that may employ the embodiment of FIG. 3.

FIG. 4 is a flowchart illustrating an embodiment of a method in accordance with the claimed subject matter.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to a cache memory for supporting multiple modes of operation, such as, a legacy mode of operation and a mode of operation that employs a 64-bit instruction set. As previously described, cache memories that support multiple modes may utilize different levels of translations.

In contrast, an embodiment of a cache memory in accordance with the claimed subject matter, such as an integrated cache may improve TLB or processor performance, or both, by reducing the number of levels of translation while also supporting multiple modes of operation, such as, a legacy mode and state of the art modes. One example of a current state of the art mode is a mode of operation that utilizes a 64-bit instruction set. The claimed subject matter, however, is not limited to state of the art modes or to modes that utilize a 64-bit instruction set. For example, state of the art modes may later include instruction sets that exceed 64 bits. In contrast, a legacy mode of operation refers to an architecture that supports 16 or 32 bit instructions for different sub-modes of operation, such as, ×86 real mode, virtual-8086 mode, and protected mode. Another type of mode is a compatibility mode that supports 16 bit, 32 bit, and 64 bit instruction sets.

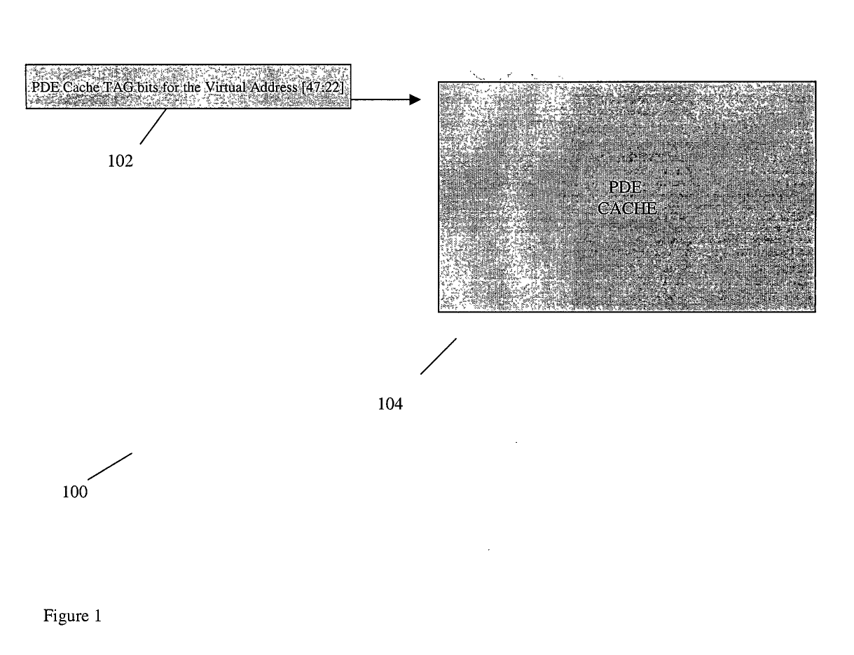

FIG. 1 is a schematic diagram illustrating an embodiment of a cache in accordance with the claimed subject matter. The figure depicts an embodiment of an integrated cache that is a combination of the levels of translations for a cache-lookup of the PDE cache 104. In contrast to the to the prior art caching structures that are physically distinct for each level, the embodiment combines the levels of translation into an integrated cache. In one embodiment, the TAG 102 refers to the input address to search the PDE cache 104.

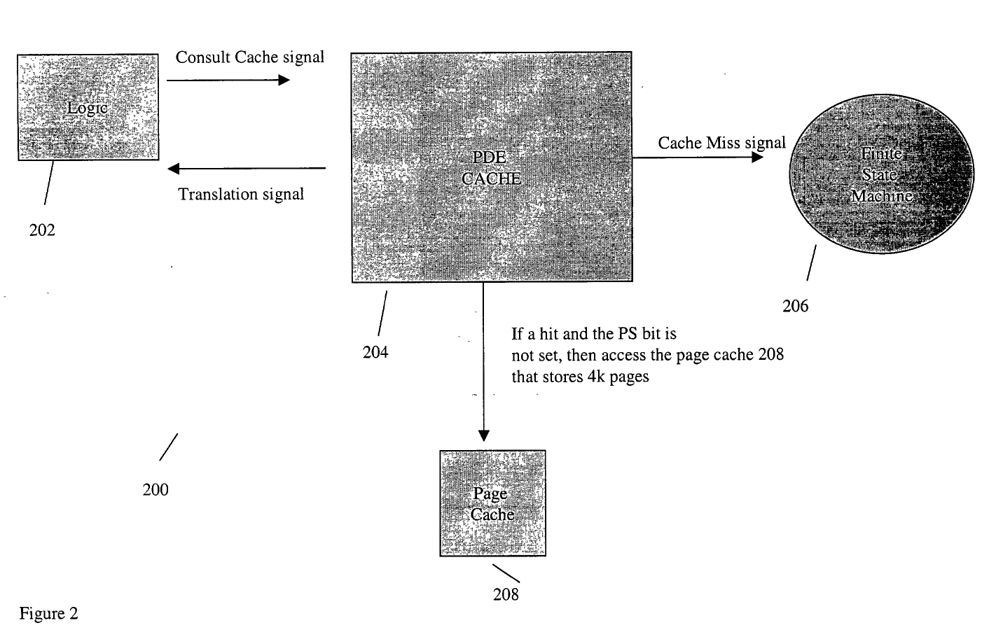

In one embodiment, the TAG 102 utilizes the bits [47:22] of a virtual address to perform a cache-lookup of the PDE cache 104 for either an ITLB or DTLB miss condition. The procedure for an ITLB or DTLB miss and cache-lookup for the TAG 102 is discussed further in connection with FIG. 2. However, the claimed subject matter is not limited to a cache lookup with bits [47:22]. For example, the cache may be integrated to allow for different virtual address bits, such as, bits [47:30].

FIG. 2 is a schematic diagram illustrating the embodiment of FIG. 1, providing additional implementation aspects. The embodiment comprises, but is not limited to, a logic 202, a PDE cache 204, a finite state machine 206, and a page cache 208.

Typically, there are two types of miss conditions for address translations, a first type is for a TLB miss and a second type is for a cache miss. As previously described, a TLB, such as an Instruction Translation Look-aside buffer (ITLB) or a Data Translation Look-aside buffer (DTLB), facilitate the address translation by storing a plurality of page tables for processing the intermediate levels of translation. Specifically, the ITLB and DTLB, store virtual addresses and corresponding physical addresses and are accessed to determine whether the respective TLB contains the physical address corresponding to a virtual address identifying a desired memory location. If the virtual and physical addresses are not stored within the TLB, then a TLB miss condition is said to have occurred. A second type of miss condition is a cache miss that occurs when the respective cache does not store an address that matches an input address that it received. Alternatively, a cache hit occurs when the respective cache does store an address that matches an input address that it received.

For one embodiment of schematic 200, the logic 202 detects a first type of miss condition, such as an ITLB miss or DTLB miss, and may forward a Consult Cache signal and an input address to the PDE Cache 204. In one embodiment the input address is a plurality of virtual address bits, such as, bits [47:22] of a 48 bit virtual address. The PDE cache comprises a plurality of entries, wherein each entry has two portions, a first and a second address. In one embodiment, the PDE cache receives the input address from the logic 202 and begins an internal search to determine whether there is a match between the input address and the first address of the plurality of entries. If so, a hit condition occurs in the PDE cache. Furthermore, if the hit condition is for a 4 k (4096 bits) page in this particular embodiment, an access may be initiated of a page cache 208 that contains a plurality of 4 k pages and results in a physical address that is forwarded to the logic 202. In one embodiment, a page size (PS) bit set to a value of logic zero for a 4 k page hit condition and is set to a value of logic one in the absence of a 4 k page hit condition.

Otherwise, for a hit condition that occurs in the PDE cache for a large page, but not for a 4 k page, the PDE cache returns the second address of the entry that had the first address that matched the input address to the logic 202. Furthermore, the address translation is complete because the second address contains a physical address. In one embodiment, the size of the large page comprises two million bits (2 Meg) or 4 million bits (4 Meg). Of course, the claimed subject matter is not limited to the preceding large page sizes. The claimed subject matter may support different large page sizes, such as, eight million bits.

In the absence of a hit condition for the PDE cache, commonly referred to as a “cache miss”, the finite state machine 206 may be invoked by a Cache Miss signal and performs an access for each of level of translation. Thus, in one aspect, the claimed subject matter reduces the latency associated with a hit condition for a PDE cache from 28 clock cycles to either 14 or 7 clock cycles. However, as previously described, the claimed subject matter is not limited to reducing the latency from 28 clock cycles to either 14 or 7 clock cycles

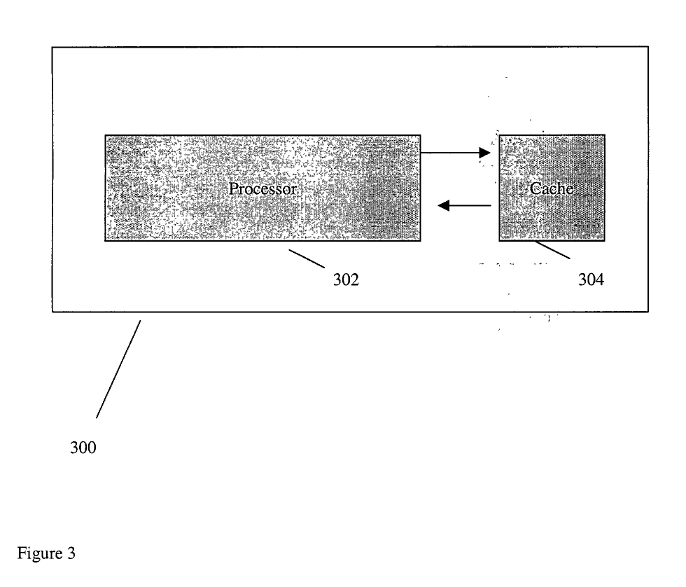

FIG. 3 is a block diagram illustrating a system that may employ the embodiment of FIG. 2. The embodiment comprises a processor 302 and an integrated cache 304. System 300 may comprise, for example, a computing system, computer, personal digital assistant, internet tablet, communication device, or an integrated device, such as, a-processor with a cache. The processor forwards a virtual address to the cache and expects the cache to return a physical address based at least in part on the received virtual address. Thus, the cache receives the virtual address and, translates it into a physical address. In one embodiment, the translation is similar to the translation depicted in connection with FIGS. 1, 2 and 4. Upon completion of the translation, the cache returns a physical address to the cache.

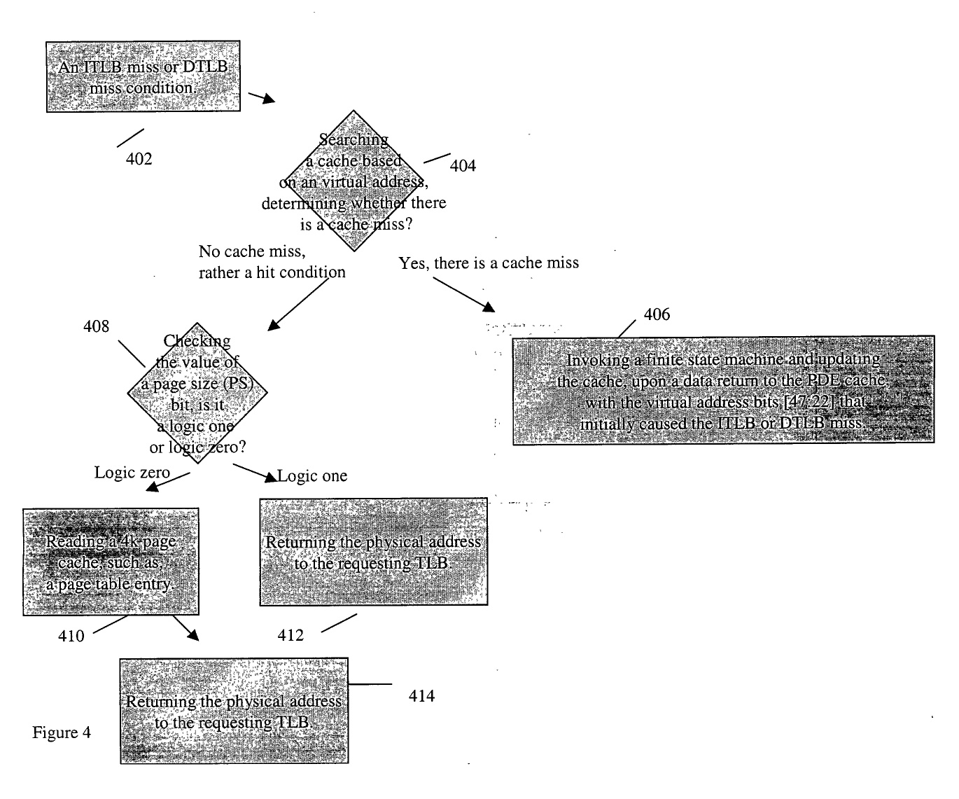

FIG. 4 is a flowchart illustrating an embodiment of a method in accordance with the claimed subject matter. The embodiment includes, but is not limited to, a plurality of diamonds and blocks 402, 404, 406, 408, 410, 412, and 414. In one embodiment, the claimed subject matter depicts translating a virtual address to a physical address for either an Instruction Translation Look-aside buffer (ITLB) miss or a Data Translation Look-aside buffer (DTLB) miss. In one embodiment, the translation is similar to the translation depicted in connection with FIGS. 2, 3 and 5. As previously described, the ITLB miss or DTLB miss exists because the information does not exist in either buffer for translating the virtual to physical address via a page-mapping scheme, as illustrated by diamond 402.

The cache is searched based at least in part on a virtual address to determine the existence of a cache-miss condition, as illustrated by diamond 404. If so, a finite state machine is invoked to perform a cache lookup for each level of translation, as illustrated by a block 406. A page size bit is analyzed, applies otherwise, as illustrated by diamond 408.

If the value of the PS bit is a logic zero value, a 4 k-page cache is searched for a physical address that may be forwarded to the requesting TLB, as illustrated by blocks 410 and 414. Otherwise, if the value of the PS bit is a logic one value, a physical address is forwarded to the requesting TLB without a search of the 4 k-page cache, as illustrated by block 412.

While certain features of the claimed subject matter have been illustrated and detailed herein, many-modifications, substitutions, changes and equivalents will now occur to those skilled in the art. It is, therefore, to be understood that the appended claims are intended to cover all such modifications and changes as fall within the true spirit of the claimed subject matter.

1. A method for translating a virtual address to a physical address comprising:
searching an integrated cache based at least in part on the virtual address;
searching a sub-memory if there is a hit condition for a first page size; and
returning the physical address to a Translation Look-aside Buffer if there is a hit condition for a second page size.

2. The method of claim 1 further comprising invoking a finite state machine if there is an integrated cache miss condition.

3. The method of claim 1 wherein the sub-memory is a page cache for storing a plurality of 4 k pages.

4. The method of claim 1 wherein translating a virtual address to a physical address comprises translating a 48 bit virtual address to a 40 bit physical address.

5. The method of claim 1 wherein returning the physical address to a Translation Look-aside Buffer comprises returning the physical address to either an Instruction Translation Look-aside Buffer (ITLB) or a Data Translation Look-aside Buffer (DTLB).

6. An apparatus to facilitate translation of a virtual address to a physical address comprising:
an integrated cache to store intermediate address translations;
the integrated cache to support at least two modes of operation.

7. The apparatus of claim 6 wherein the integrated cache is to store intermediate address translations to support at least the two modes of operation of the cache.

8. The apparatus of claim 6 wherein the at least two modes of operation comprise a legacy mode and a compatibility mode.

9. The apparatus of claim 8 wherein the legacy mode is to support a 16 bit and a 32 bit instruction set and the compatibility mode is to support the 16 bit, the 32 bit, and a 64 bit instruction set.

10. The apparatus of claim 8 wherein the legacy mode is adapted to utilize two intermediate levels of translation and the compatibility mode is adapted to utilize four intermediate levels of translation.

11. The apparatus of claim 10 wherein the integrated cache is to store intermediate address translations for PMLA, PDP, and PDE levels.

12. The apparatus of claim 10 wherein the integrated cache is to support a miss condition from a Translation Look-aside Buffer (TLB).

13. The apparatus of claim 12 wherein the TLB is either an Instruction Translation Look-aside Buffer (ITLB) or a Data Translation Look-aside Buffer (DTLB).

14. An apparatus to facilitate a translation of a virtual address to a physical address comprising:
an integrated cache having a configuration to support a plurality of fields of the virtual address;
the integrated cache to store intermediate address translations based at least in part on the plurality of fields; and
a memory, coupled to the integrated cache, to store a plurality of pages of a first page size.

15. The apparatus of claim 14 wherein the memory comprises a page cache.

16. The apparatus of claim 14 wherein the integrated cache is to support at least two modes of operation of the apparatus.

17. The apparatus of claim 16 wherein the at least two modes of operation comprise a legacy mode and a compatibility mode.

18. The apparatus of claim 17 wherein the legacy mode is to support a 16 bit and a 32 bit instruction set and the compatibility mode is to support the 16 bit, the 32 bit, and a 64 bit instruction set.

19. The apparatus of claim 17 wherein the apparatus is incorporated in a microprocessor.

20. The apparatus of claim 15 wherein the page cache is to store a plurality of 4 k pages.

21. The apparatus of claim 17 wherein the legacy mode is adapted to utilize two intermediate levels of translation and the compatibility mode is adapted to utilize four intermediate levels of translation.

22. The apparatus of claim 17 wherein the integrated cache is to store intermediate address translations for PML4, PDP, and PDE levels.

23. The apparatus of claim 17 wherein the integrated-cache is to support a miss condition from either an Instruction Translation Look-aside Buffer (ITLB) or a Data Translation Look-aside Buffer (DTLB).

24. The apparatus of claim 23 wherein the physical address comprises 40 bits and the virtual address comprises 48 bits.

25. A system comprising:
a processor; and
an integrated cache, coupled to the processor, to facilitate a translation of a virtual address to a physical address;
the integrated cache to support a first mode and a second mode of operation based at least in part on intermediate address translations.

26. The system of claim 25 wherein the system comprises at least one of an integrated device, a computer system, a computing system, a personal digital assistant, and a communication device.

27. The system of claim 23 wherein the first mode of operation is a legacy mode to support a 16 bit and a 32-bit instruction set and the second mode of operation is a compatibility mode is to support the 16 bit, the 32 bit, and a 64-bit instruction set.

28. The system of claim 25 wherein the legacy mode is adapted to utilize two intermediate levels of translation and the compatibility mode is adapted to utilize four intermediate levels of translation.

29. The system of claim 25 wherein the integrated cache is to store intermediate address translations for PMN, PDP, and PDE levels.
